(19) United States
(12) Patent Application Publication
(10) Pub. No.: US 2022/0065022 A1
(43) Pub. Date: Mar. 3, 2022

(54) SYSTEM AND METHOD FOR MANAGING OPENING AND CLOSING OF A VEHICLE WINDOW

(71) Applicant: Ningbo Geely Automobile Research & Development Co., Ltd., Ningbo (CN)

(72) Inventors: Magnus NILSSON, Floda (SE); Erik LINDBERG NILSSON, Göteborg (SE)

(21) Appl. No.: 17/522,495

(22) Filed: Nov. 9, 2021

Related U.S. Application Data
(63) Continuation of application No. PCT/CN2020/092116, filed on May 25, 2020.

(30) Foreign Application Priority Data
May 29, 2019 (EP) 19177177.3

(51) Int. Cl. E05F 15/73; E05F 15/695

(52) U.S. Cl. CPC E05F 15/73; E05F 15/695; E05F 2015/767; E05Y 2400/822; E05Y 2900/55; E05Y 2400/86; E05Y 2400/82

(57) ABSTRACT

A system, method and computer program product for detecting, by at least a first sensor, a position and/or movement of an object at or on at least first window, determining, if the position and/or movement of the object detected by the at least first sensor represents an intention by a vehicle occupant to move the at least first window, and responsive to a determination that the position and/or movement of the of the object represents an intention by the vehicle occupant to move the at least first window, cause the at least first window controller to initiate a movement of the at least first window accordingly.

### RELATED APPLICATION DATA

This application is a continuation of International Patent Application No. PCT/CN2020/092116, filed May 25, 2020, which claims the benefit of European Patent Application No. 19177177.3, filed May 29, 2019, the disclosures of which are incorporated herein by reference in their entireties.

### TECHNICAL FIELD

The disclosure pertains to the field of opening and closing of a vehicle window.

### BACKGROUND

Most vehicles today are equipped with windows that can be opened and closed. Opening and closing of the windows is desired for many different reasons. A common reason is to make the vehicle compartment climate comfortable for the vehicle occupants, e.g. a pleasant summer day it may be desired to open the windows and let some of the air into the vehicle compartment. But it is also desired to open the window for other reasons, to e.g. get a ticket when entering a parking garage etc. Some vehicle windows can be opened manually by manpower, by using a crank, to move the window up or down. Most modern vehicles today are however equipped with windows that can be opened and closed with help from e.g. an electric motor. The vehicle occupant then uses a switch to operate the opening and closing of the window. The switch is often mounted on the door that comprises the window to be opened or closed. The switch can also be mounted on the control panel or e.g. between the driver and the passenger seats. The switch often comprises one or more buttons that are operated by e.g. pressing or dragging the buttons.

### SUMMARY

There is a demand for an easier and more convenient way to control the opening and closing of a vehicle window. In particular there is a need for an intuitive way to control the opening and closing of a vehicle window that does not require a dedicated control switch with buttons mounted on the door or elsewhere in the vehicle compartment. An object of the present disclosure is to provide vehicle window control system and method for managing the opening and closing of a window which seek to mitigate, alleviate, or eliminate one or more of the above-identified deficiencies in the art and disadvantages singly or in any combination.

The disclosure proposes a vehicle window control system for managing movement of at least a first window. The vehicle window control system comprises at least a first window controller configured to move the at least first window and at least a first sensor configured to detect a position and/or movement of an object. The vehicle window control system further comprises a processing circuitry operatively connected to the at least first sensor and the at least first window controller. The processing circuitry is configured to cause the window control system to detect a position and/or movement of an object at or on the at least first window and determine, if the position and/or movement of the object detected by the at least first sensor represents an intention by a vehicle occupant to move the at least first window, and responsive to a determination that the position and/or movement of the of the object represents an intention by the vehicle occupant to move the at least first window, cause the at least first window controller to initiate a movement of the at least first window accordingly. An advantage with the vehicle window control system is that the vehicle occupant can operate the at least first window intuitively by e.g. a finger at or on the window, without the need for a certain switch or button for operating the at least first window.

According to an aspect the intention by the vehicle occupant to move the window is determined by that the position of the object is at a first position within at least a first active area at or on the at least first window and the movement of the at least first window is a first movement of the at least a first window. This means that when the object is at the first position within the at least a first active area, the operation of the at least first window can be one of a plurality of predefined operations causing the at least first window to move accordingly.

According to an aspect the processing circuitry is configured to cause the window control system to further determine a second position of the object within the at least first active wherein the second position of the object is determined within a certain time from the determination of the first position of the object, and cause the at least a first window controller to initiate a movement of the at least first window that is a second movement of the at least first window. This means that when the object is moved from one position to another, e.g. swiped, from the first position to the second position, the operation of the at least first window can be one of a plurality of predefined operations causing the at least first window to move accordingly.

According to an aspect the at least first sensor is configured to emit light and detect a reflection of the emitted light caused by the object. In other words if the object comes in the way of the emitted light, the position of the object can be determined by the reflected light.

According to an aspect the at least first sensor is configured to detect light from at least a first light source. An advantage with this aspect is that it can be detected if the object comes in between the at least first light source and the at least first sensor for determining the position of the object.

According to an aspect the at least first light source is configured to emit light with a certain wavelength and/or emit a pulsing light that is pulsing at a certain frequency. An advantage with light with a certain wavelength and/or a pulsing light that is pulsing at a certain frequency is that the at least first sensor can be configured to only detect light with the certain wavelength and/or the certain pulse frequency of the pulsing light for determining the position of the object.

According to an aspect, the at least first sensor is configured to determine at least one of a distance and a direction to the object relative to the position of the at least first sensor. In other words this means that the position of the object can be determined.

According to an aspect the at least first sensor is configured to determine a position of the object, relative to the position of the at least first window. An advantage with this aspect is that since the at least first window is movable, the position of the object relative to the at least first window can be changed dynamically when the at least first window is moving, compared to the position of the object relative to the at least first sensor that is static.

According to an aspect the at least first window comprising at least a first symbol. According to an aspect the at least first window comprising at least a first symbol. According to an aspect the at least first window comprising at least a first symbol, wherein the at least first symbol is displayed only when the at least first symbol is lit by light. This means that the at least first symbol can be seen only when lit by light and e.g. be transparent if not lit by light in order to provide a see-through window.

According to an aspect the at least first window comprising at least a first layer and the at least first symbol is comprised in the at least first layer. According to an aspect the at least first window comprising at least a first layer and a second layer and the first symbol is comprised in the first layer and a second symbol is comprised in the second layer. This solution provides for e.g. the advantage that different symbols can be comprised in different layers of the at least first window.

The disclosure further proposes a method for managing movement of at least a first window. The method comprising the step of detecting, by at least a first sensor, a position and/or movement of an object at or on the at least first window. The method further comprising the step of determining, if the position and/or movement of the object detected by the at least first sensor represents an intention by a vehicle occupant to move the at least first window and responsive to a determination that the position and/or movement of the of the object represents an intention by the vehicle occupant to move the at least first window, cause the at least first window controller to initiate a movement of the at least first window accordingly. An advantage with the vehicle window control system is that the vehicle occupant can operate the at least first window intuitively by e.g. a finger at or on the window, without the need for a certain switch or button for operating the at least first window.

According to an aspect the intention by the vehicle occupant to move the at least first window is determined by that the position of the object is at a first position within at least a first active area at or on the at least first window and that the movement of the at least first window is a first movement of the at least first window. This means that when the object is at the first position within the at least a first active area, the operation of the at least first window can be one of a plurality of predefined operations causing the at least first window to move accordingly.

According to an aspect the method further comprising a determination of a second position of the object within the at least first active area, and the second position of the object is determined within a certain time from the determination of the first position of the object, causing the at least a first window controller to initiate a movement of the at least first window that is a second movement of the at least a first window. This means that when the object is moved from one position to another, e.g. swiped, from the first position to the second position, the operation of the at least first window can be one of a plurality of predefined operations causing the at least first window to move accordingly.

The disclosure further proposes a computer program product comprising a non-transitory computer readable medium, having thereon a computer program comprising program instructions, the computer program being loadable into a processing circuitry and configured to cause execution of the method when the computer program is run by the at least one processing circuitry.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1A illustrates a vehicle window control system according to an aspect of the disclosure.

FIG. 1B illustrates an overview of a vehicle with doors and windows according to an aspect of the disclosure.

FIG. 2A illustrates the object at a first position within an active area at or on a window according to an aspect of the disclosure.

FIG. 2B illustrates the object at a second position within an active area at or on a window according to an aspect of the disclosure.

FIG. 3 illustrates example symbols and active areas at or on a window according to an aspect of the disclosure.

FIG. 4A illustrates example symbols and active areas at or on a window in a closed position according to an aspect of the disclosure.

FIG. 4B illustrates example symbols and active areas at or on a window in an example half open position according to an aspect of the disclosure.

FIG. 5 illustrates a window that comprises at least a first layer according to an aspect of the disclosure.

FIGS. 6A-6C illustrates window layers and at least a first symbol comprised in each layer.

FIG. 7 illustrates a flow chart of the method steps according to some aspects of the disclosure.

FIG. 8 illustrates a computer program product according to some aspects of the disclosure.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Today most modern vehicles are equipped with windows that can be opened and closed with help from e.g. an electric motor. The vehicle occupant commonly uses a switch to operate the opening and closing of the window. The switch is often mounted on the door that comprises the window to be opened or closed. The switch can also be mounted on the control panel or e.g. between the driver and the passenger seats. The switch often comprises one or more buttons that are operated by e.g. pressing or dragging the buttons.

There is a demand for an easier and more convenient way to control the opening and closing of a vehicle window. In particular there is a need for an intuitive way to control the opening and closing of a vehicle window that does not require a dedicated control switch with buttons mounted on the door or elsewhere in the vehicle compartment. An object of the present disclosure is to provide vehicle window control system and method for managing the opening and closing of a window which seek to mitigate, alleviate, or eliminate one or more of the above-identified deficiencies in the art and disadvantages singly or in any combination.

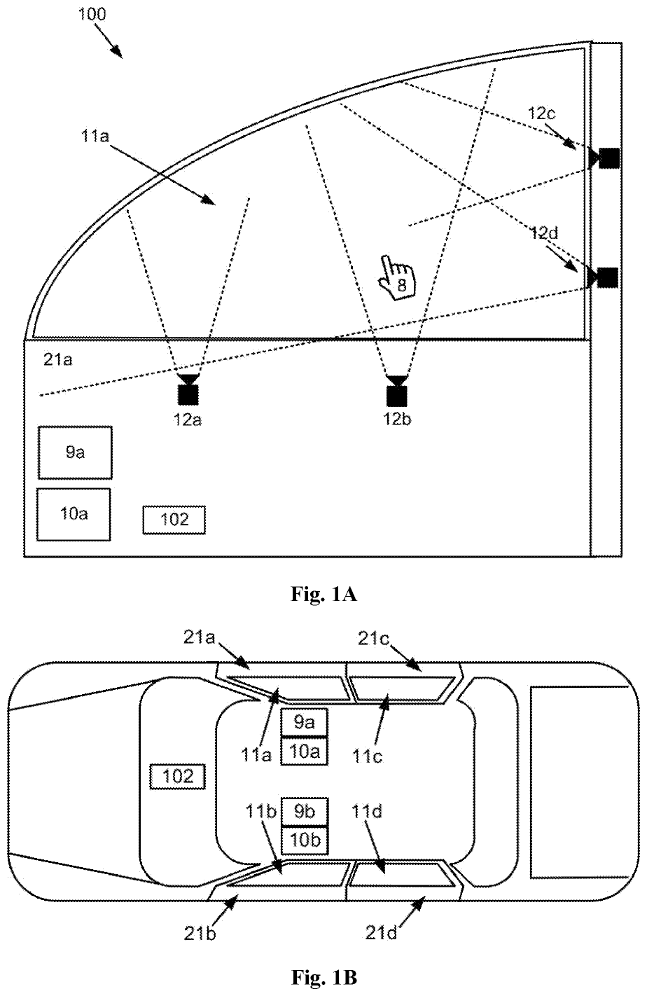

The disclosure proposes a vehicle window control system 100 for managing movement of at least a first window 11a, 11b, 11c, 11d. As illustrated in FIGS. 1A and 1B, the vehicle window control system 100 comprises at least a first window controller 10a, 10b configured to move the at least first window 11a, 11b, 11c, 11d. According to an aspect the at least first window controller 10a, 10b is configured to activate motors 9a, 9b that move the at least first window 11a, 11b, 11c, 11d. FIG. 1B illustrates an overview of a vehicle with doors and windows according to an aspect of the disclosure. The example vehicle in FIG. 1B has four doors 21a, 21b, 21c, 21d all with windows 11a, 11b, 11c, 11d. According to an aspect the at least first window controller 10a, 10b is comprised in the door 21a, 21b, 21c, 21d. As illustrated in FIG. 1A the vehicle window control system 100 further comprises at least a first sensor 12a, 12b, 12c, 12d configured to detect a position and/or movement of an object 8. The FIG. 1A illustrates a vehicle window control system according to an aspect of the disclosure. In the illustration in FIG. 1A four sensors 12a, 12b, 12c, 12d are illustrated. If more sensors are used a more precise detection of the position and/or the movement of the object 8 can be determined. According to an aspect the sensor 12a, 12b, 12c, 12d may have the size of the full length of the at least first window 11a, 11b. According to an aspect the sensor 12a, 12b, 12c, 12d may have the size of the full height of the at least first window 11a, 11b. According to an aspect a plurality of sensors 12a, 12b, 12c, 12d are mounted around the window of the door 21a, 21b, 21c, 21d.

According to an aspect the object 8 is any object. According to an aspect the object 8 is a part of the vehicle occupant, e.g. a finger or a hand of the vehicle occupant. According to an aspect the position and/or movement of a finger or a hand is detected on or at the inside of the at least first window 11a, 11b from a vehicle occupant inside of the vehicle.

The vehicle window control system 100 further comprises a processing circuitry 102 operatively connected to the at least first sensor 12a, 12b, 12c, 12d and the at least first window controller 10a, 10b. As illustrated in FIG. 1A the processing circuitry 102 is comprised in the door 21a. As illustrated in FIG. 1B the processing circuitry 102 is the processing circuitry of the vehicle on-board computer. The processing circuitry 102 is configured to cause the window control system 100 to detect a position and/or movement of an object 8 at or on the at least first window 11a, 11b, 11c, 11d and determine, if the position and/or movement of the object 8 detected by the at least first sensor 12a, 12b, 12c, 12d, represents an intention by a vehicle occupant to move the at least first window 11a, 11b, 11c, 11d.

According to an aspect the intention by the vehicle occupant to move the at least first window 11a, 11b, 11c, 11d is determined by that the position of the object 8 is within a predefined position at the at least first window 11a, 11b, 11c, 11d. According to an aspect the determination that the object 8 is within a predefined position at the at least first window 11a, 11b, 11c, 11d causes the at least first window controller 10a, 10b to initiate a predetermined movement of the at least first window 11a, 11b, 11c, 11d.

According to an aspect the intention by the vehicle occupant to move the at least first window 11a, 11b, 11c, 11d is determined by that the movement of the object 8 corresponds to a predetermined movement at the at least first window 11a, 11b, 11c, 11d. According to an aspect a movement of the object 8 is an upwards movement which causes the at least first window controller 10a, 10b to initiate an upwards movement of the at least first window 11a, 11b, 11c, 11d. According to an aspect a movement of the object 8 is a downwards movement which causes the at least first window controller 10a, 10b to initiate an downward movement of the at least first window 11a, 11b, 11c, 11d.

According to an aspect the position and/or movement of the object 8 is detected on the at least first window 11a, 11b, 11c, 11d.

According to an aspect the at least first window controller 10a, 10b is configured to initiate a movement of the at least first window 11a, 11b, 11c, 11d as long as the position and/or movement of the object 8 detected by the at least first sensor 12a, 12b, 12c, 12d. In an example, as long as a finger is detected on the at least first window 11a, 11b, 11c, 11d, the at least first window 11a, 11b, 11c, 11d is moving. In an example, when the at least a first sensor 12a, 12b, 12c, 12d does not detect a finger on the at least first window 11a, 11b, 11c, 11d the at least first window controller 10a, 10b cease movement of the at least first window 11a, 11b, 11c, 11d.

According to an aspect the position and/or movement of the object 8 is detected at the at least first window 11a, 11b, 11c, 11d.

In an example the position and/or movement of the object 8 is detected at the door 21a, 21b, 21c, 21d around the at least first window 11a, 11b, 11c, 11d.

According to an aspect the position and/or movement of the object 8 is detected at a predefined location at a door 21a, 21b, 21c, 21d arranged at the at least first window 11a, 11b, 11c, 11d.

The processing circuitry 102 is configured to cause the window control system 100 to detect a position and/or movement of an object 8 at or on the at least first window 11a, 11b, 11c, 11d and determine, if the position and/or movement of the object 8 detected by the at least first sensor 12a, 12b, 12c, 12d represents an intention by a vehicle occupant to move the at least first window 11a, 11b, 11c, 11d, and in responsive to a determination that the position and/or movement of the of the object 8 represents an intention by the vehicle occupant to move the at least first window 11a, 11b, 11c, 11d, cause the at least first window controller 10a, 10b to initiate a movement of the at least first window 11a, 11b, 11c, 11d accordingly. An advantage with the vehicle window control system 100 is that the vehicle occupant can operate the at least first window 11a, 11b, 11c, 11d intuitively by e.g. a finger at or on the window, without the need for a certain switch or button for operating the at least first window 11a, 11b, 11c, 11d.

FIG. 1A illustrates a vehicle window control system according to an aspect of the disclosure. In the illustration in FIG. 1A, the object 8 is in form of a finger of the vehicle occupant. The sensors 12b and 12d detect the finger. In an example the finger is touching the window 11a. In an example the finger is not touching the window 11a. According to an aspect an upwards movement of the object 8, e.g. the finger, causes the window 11a to move upwards. According to an aspect a downwards movement of the object 8, e.g. the finger, causes the window 11a to move downwards. According to an aspect the detection of the object 8 at a certain position causes the window to go from a moving state to a non-moving state, e.g. to a stop. In a use case example with reference to FIG. 1A, a downwards movement of the finger 8 is detected by the sensors 12b, 12c and 12d which causes the window 11a to move downwards. While the window 11a is moving downwards another position of the finger 8 is detected by the sensors 12b and 12d that causes the window 11b to go from the moving state to a stop.

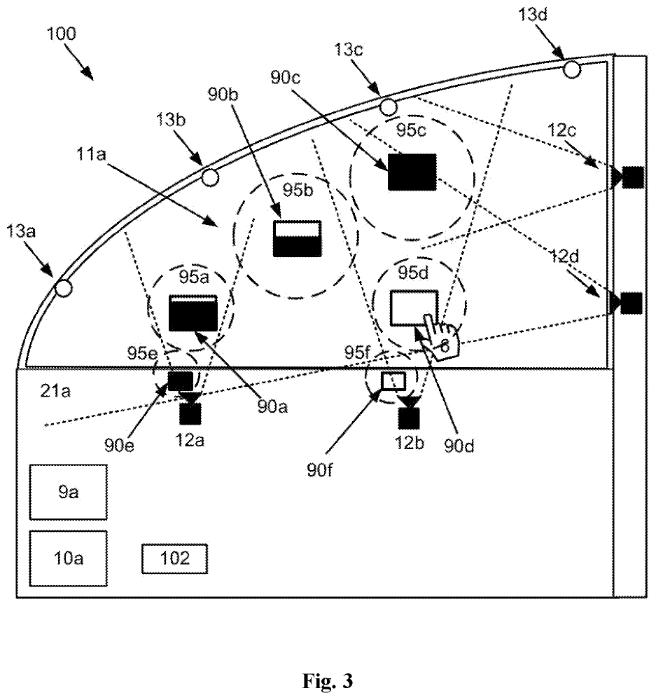

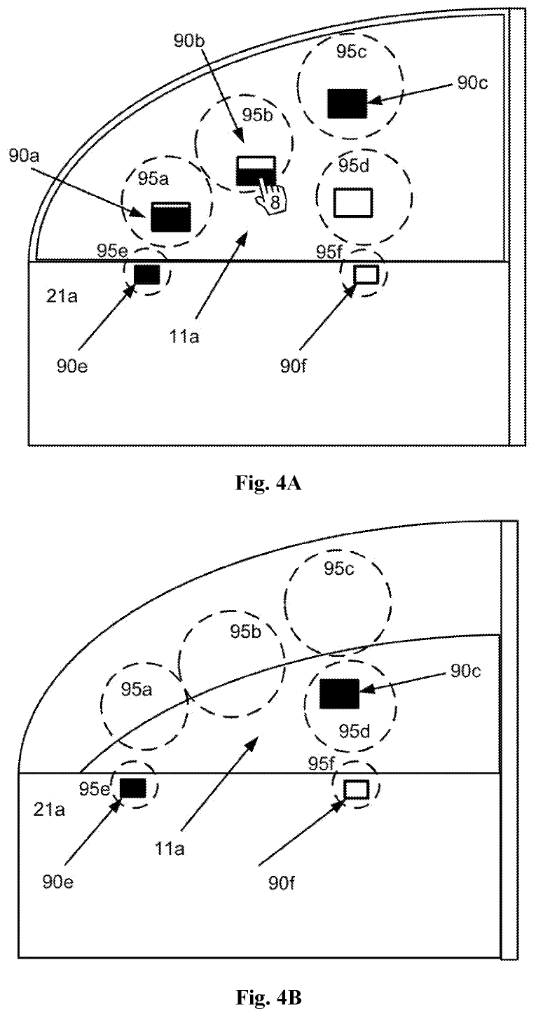

According to an aspect, the intention by the vehicle occupant to move the window is determined by that the position of the object 8 is at a first position P1 within at least a first active area 95a, 95b, 95c, 95d, 95e, 95f at or on the at least first window 11a, 11b, 11c, 11d and the movement of the at least first window 11a, 11b, 11c, 11d is a first movement of the at least a first window 11a, 11b, 11c, 11d. Example active areas 95a, 95b, 95c, 95d, 95e, 95f are visualised in FIG. 3. This means that when the object 8 is at the first position P1 within the at least a first active area 95a, 95b, 95c, 95d, 95e, 95f, the operation of the at least first window 11a, 11b, 11c, 11d can be one of a plurality of predefined operations causing the at least first window 11a, 11b, 11c, 11d to move accordingly. In an example, as illustrated in FIG. 4A followed by FIG. 4B, the first movement of the window 11a is to half open the window 11a.

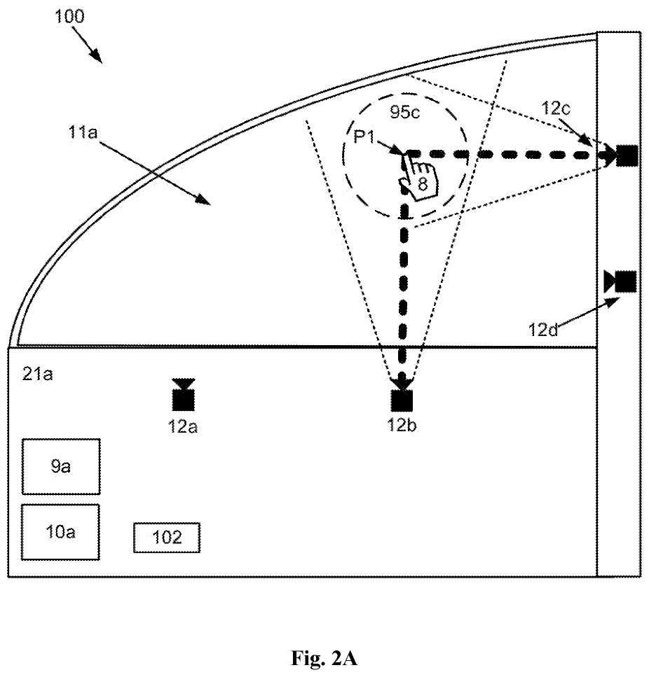

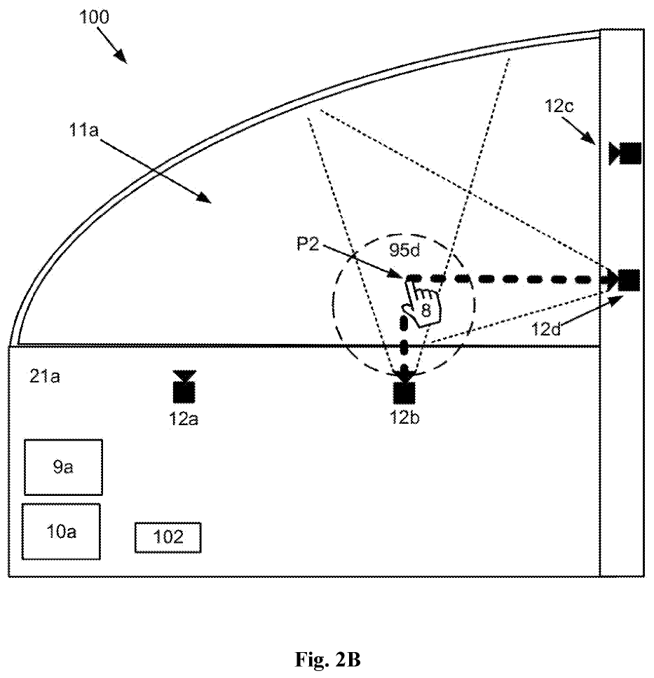

FIG. 2A illustrates the object 8 at a first position P1 within the active area 95c at or on the window 11a according to an aspect of the disclosure. In the illustration in FIG. 2A, the object 8 is in form of a finger of the vehicle occupant. In the example, the sensors 12b and 12c detects the finger 8 at the first position P1 within the active area 95c. In an example the finger 8 is touching the window 11a within the active area 95c. In an example the finger is not touching the window 11a, however the finger is within the active area 95c.

According to an aspect the at least first active area 95a, 95b, 95c, 95d, 95e, 95f is defined by an area where at least a first sensor 12a, 12b, 12c, 12d is configured to detect a position and/or movement of an object 8. According to an aspect the at least first active area 95a, 95b, 95c, 95d, 95e, 95f is a sub area of at least a second active area 95a, 95b, 95c, 95d, 95e, 95f According to an aspect the at least first active area 95a, 95b, 95c, 95d, 95e, 95f overlaps with at least a second active area 95a, 95b, 95c, 95d, 95e, 95f.

According to an aspect the at least first active area 95a, 95b, 95c, 95d, 95e, 95f is defined by an area where at least a first sensor 12a, 12b, 12c, 12d is configured to detect a position and/or movement of an object 8 independent of if the at least first window 11a, 11b, 11c, 11d is present in the at least first active area 95a, 95b, 95c, 95d, 95e, 95f or not. According to an aspect the at least first active area 95a, 95b, 95c, 95d, 95e, 95f is the area in the air if the at least first window 11a, 11b, 11c, 11d is not present.

According to an aspect the at least first active area 95a, 95b, 95c, 95d, 95e, 95f is defined in a two dimensional plane. In an example the at least first active area 95a, 95b, 95c, 95d, 95e, 95f is a surface at or on the at least first window 11a, 11b, 11c, 11d. In an example the surface is the window surface. In an example the surface is the surface of the door. According to an aspect the at least first active area 95a, 95b, 95c, 95d, 95e, 95f is defined in a three dimensional plane. In an example the at least first active area 95a, 95b, 95c, 95d, 95e, 95f is a spherical space at or on the at least first window 11a, 11b, 11c, 11d.

According to an aspect the at least first active area 95a, 95b, 95c, 95d, 95e, 95f corresponds to a predefined operation of the at least first window 11a, 11b, 11c, 11d. According to an aspect the at least first active area 95a, 95b, 95c, 95d, 95e, 95f corresponds to a predefined operation of the at least first window 11a, 11b, 11c, 11d dependent on the position of the at least first window 11a, 11b, 11c, 11d. According to an aspect the position of the at least first window 11a, 11b, 11c, 11d can be any position between a closed state and a fully open state.

In an example, a determination that a finger is at the same position, i.e. not moving, cause a first movement of the at least first window 11a, 11b, 11c, 11d that represents a predefined movement dependent on where the finger is positioned e.g. to open the window by half.

According to an aspect the at least first window controller 10a, 10b is configured to initiate a movement of the at least first window 11a, 11b, 11c, 11d after determination that the position of the object 8 is at a first position P1 within at least a first active area 95a, 95b, 95c, 95d, 95e, 95f at or on the at least first window 11a, 11b, 11c, 11d during a predefined time period.

According to an aspect, responsive to a determination that the position of the object 8 is at a first position P1 within at least a first active area 95a, 95b, 95c, 95d, 95e, 95f at or on the at least first window 11a, 11b, 11c, 11d longer than a predefined time period, causing a fourth movement of the at least first window 11a, 11b, 11c, 11d. In an example the fourth movement is an upwards movement that completely closes the window 11a.

According to an aspect the processing circuitry 102 is configured to cause the window control system 100 to further determine a second position P2 of the object 8 within the at least first active area 95a, 95b, 95c, 95d, 95e, 95f wherein the second position P2 of the object 8 is determined within a certain time from the determination of the first position P1 of the object 8, and cause the at least a first window controller 10a, 10b to initiate a movement of the at least first window 11a, 11b, 11c, 11d that is a second movement of the at least first window 11a, 11b, 11c, 11d. This means that when the object 8 is moved from one position to another, e.g. swiped, from the first position P1 to the second position P2, the operation of the at least first window 11a, 11b, 11c, 11d can be one of a plurality of predefined operations causing the at least first window 11a, 11b, 11c, 11d to move accordingly.

FIG. 2B illustrates the object 8 at a second position P2 within the active area 95d at or on the window 11a according to an aspect of the disclosure. In the illustration in FIG. 2B, the object 8 is in form of a finger of the vehicle occupant. In the example, the sensors 12b and 12d detect the finger 8 at the second position P2 within the active area 95d. In an example the finger 8 is touching the window 11a within the active area 95d. In an example the finger is not touching the window 11a but the finger is within the active area 95d. In the example as illustrated in FIG. 2B the second position P2 of the object 8 is determined within a certain time from the determination of the first position P1 of the object 8, as illustrated in FIG. 2A, and cause the at least a first window controller 10a, 10b to initiate a movement of the at least first window 11a, 11b, 11c, 11d that is a second movement of the at least first window 11a, 11b, 11c, 11d. In the example a swipe of the finger 8 that is moving downwards, from the first position P1 to the second position P2, is detected that causes the window 11a to initiate the second movement, e.g. a downwards movement of the window 11a.

According to an aspect the movement of the object 8 is detected when the object 8 is first detected in one active area 95a, 95b, 95c, 95d, 95e, 95f and then within a certain time the object is detected in another active area 95a, 95b, 95c, 95d, 95e, 95f. According to an aspect movement of the object 8 is detected within the same active area 95a, 95b, 95c, 95d, 95e, 95f.

According to an aspect an upward movement of a finger from a first position P1 to a second position P2 causes the at least first window 11a to close to a certain extent.

According to an aspect any of the distance, or the speed of the movement, between the first position P1 and the second position P2 determines to what extent the at least first window 11a, 11b, 11c, 11d moves. In an example the speed of the movement causes the at least first window 11a, 11b, 11c, 11d to move in a correlating speed. For example if the vehicle occupant swipes a finger fast in an upwards movement, the window is closing fast. In an example the distance of the movement causes the at least first window 11a, 11b, 11c, 11d to move in a correlating distance. For example if the vehicle occupant swipes a finger a certain distance at or on the window in an upwards movement, the window is moving upwards the same distance.

According to an aspect the intention by the vehicle occupant to move the window is determined by that the position of the object 8 is at a second position P2 within at least a first active area 95a, 95b, 95c, 95d, 95e, 95f at or on the at least first window 11a, 11b, 11c, 11d and the movement of the at least first window 11a, 11b, 11c, 11d is a third movement of the at least a first window 11a, 11b, 11c, 11d. In an example the third movement is to fully open the window 11a.

According to an aspect the at least first sensor 12a, 12b, 12c, 12d is configured to emit light and detect a reflection of the emitted light caused by the object 8. In other words if the object 8 comes in the way of the emitted light, the position of the object 8 can be determined by the reflected light.

According to an aspect the at least first sensor 12a, 12b, 12c, 12d is configured to detect light from at least a first light source 13a, 13b, 13c, 13d. FIG. 3 illustrates example light sources 13a, 13b, 13c, 13d. An advantage with this aspect is that it can be detected if the object 8 comes in between the at least first light source 13a, 13b, 13c, 13d and the at least first sensor 12a, 12b, 12c, 12d for determining the position of the object 8.

According to an aspect the at least first light source 13a, 13b, 13c, 13d is configured to emit light with a certain wavelength and/or emit a pulsing light that is pulsing at a certain frequency.

According to an aspect the at least first sensor 12a, 12b, 12c, 12d is configured to emit light with a certain wavelength and/or emit a pulsing light that is pulsing at a certain frequency.

An advantage with light with a certain wavelength and/or a pulsing light that is pulsing at a certain frequency is that the at least first sensor 12a, 12b, 12c, 12d can be configured to only detect light with the certain wavelength and/or the certain pulse frequency of the pulsing light for determining the position of the object 8.

According to an aspect the at least first light source 13a, 13b, 13c, 13d is configured to emit light and the at least first sensor 12a, 12b, 12c, 12d is configured to detect an interruption of the emitted light. According to an aspect the at least first sensor 12a, 12b, 12c, 12d is configured to emit light the at least first sensor 12a, 12b, 12c, 12d is further configured to detect a reflection of the emitted light.

In other words if the at least first light source 13a, 13b, 13c, 13d is used to emit light with a certain wavelength and/or a pulsing light, that is pulsing at a certain frequency, the at least first sensor 12a, 12b, 12c, 12d can be configured to detect an interruption of the specific light with the certain wavelength and/or the certain pulsing light, that is pulsing at the certain frequency.

Further, if the at least first sensor 12a, 12b, 12c, 12d is used to emit light with a certain wavelength and/or a pulsing light, that is pulsing at a certain frequency, the at least first sensor 12a, 12b, 12c, 12d can be configured to detect reflection of the specific light with the certain wavelength and/or the certain pulsing light, that is pulsing at the certain frequency.

In an example, light with a wavelength that is invisible by a human, such as infrared light, is used.

According to an aspect, the specific light with the certain wavelength is used for detecting a certain object with a certain colour. In an example the specific light with the certain wavelength is used for excluding detection of a certain object with a certain colour.

According to an aspect, the at least first sensor 12a, 12b, 12c, 12d is configured to determine at least one of a distance and a direction to the object 8 relative to the position of the at least first sensor 12a, 12b, 12c, 12d. In other words this means that the position of the object 8 can be determined. In an example the at least first sensor 12a, 12b, 12c, 12d is directed in a known direction and mounted at a known position and together with a known relation to at least a second sensor 12a, 12b, 12c, 12d directed in a known direction and mounted at a known position, the distance and the direction to the object 8 can be determined by the at least first sensor 12a, 12b, 12c, 12d and the at least second sensor 12a, 12b, 12c, 12d. In the illustration in FIG. 2A, the sensor 12b is directed in a known direction and mounted at a known position in relation to the sensor 12c that is also directed in a known direction and mounted at a known position in relation to the sensor 12b. In the example illustrated in FIG. 2A the two sensors 12b and 12c can together determine the position of the object 8 at the first position P1.

According to an aspect the at least first window 11a, 11b, 11c, 11d comprising at least a first symbol 90a, 90b, 90c, 90d, 90e, 90f According to an aspect the at least first symbol 90a, 90b, 90c, 90d, 90e, 90f is arranged at the at least first active area 95a, 95b, 95c, 95d, 95e, 95f. According to an aspect the at least first window 11a, 11b, 11c, 11d comprising at least a first symbol 90a, 90b, 90c, 90d, 90e, 90f, wherein the at least first symbol 90a, 90b, 90c, 90d, 90e, 90f is displayed only when the at least first symbol 90a, 90b, 90c, 90d, 90e, 90f is lit by light. This means that the at least first symbol 90a, 90b, 90c, 90d, 90e, 90f can be seen only when lit by light and e.g. be transparent if not lit by light in order to e.g. provide a see-through window or a clean surface of the door.

FIG. 3 illustrates example symbols 90a, 90b, 90c, 90d, 90e, 90f and active areas 95a, 95b, 95c, 95d, 95e, 95f at or on a window according to an aspect of the disclosure. In FIG. 3 the example symbol 90a illustrates a window that is just partly open. The example symbol 90b illustrates a window that is half open. The example symbols 90c and 90e illustrates a window that is closed. Further, the example symbols 90d and 90f illustrates a fully opened window.

In the example illustrations in FIG. 3, the symbol “partly open” 90a is within the active area 95a. The symbol “half open” 90b is within the active area 95b. The symbol “closed” 90c and 90e is within the active area 95c and the active area 95e respectively. The symbol “fully opened” 90d and 90f is within the active area 95d and the active area 95f respectively.

According to an aspect the door 21a comprising at least a first symbol 90e, 90f at a predetermined position at the door 21a. According to an aspect the at least first symbol 90e, 90f at the predetermined position of the door 21a is only visible when lit by light. In the example as illustrated in FIG. 3 the symbols at the door 21a, “closed” 90e and “fully opened” 90f are always at the same predetermined position at the door 21a. In other words the vehicle occupant will always know where to put the finger at the door in order to either fully open or to close the window. According to an aspect, in responsive to a determination that the position and/or movement of the of the object 8 is within the active area 95e, 95f of the predetermined position of the door 21a, cause the at least first window controller 10a to initiate a movement of the at least first window 11a. According to an aspect, in responsive to a determination that the position and/or movement of the of the object 8 is within the area of the predetermined position of the door 21a, cause the at least first window controller 10a to initiate any of at a closing movement or an open movement of the window 11a.

According to an aspect the at least first sensor 12a, 12b, 12c, 12d is configured to determine a position of the object 8, relative to the position of the at least first window 11a, 11b, 11c, 11d. An advantage with this aspect is that since the at least first window 11a, 11b, 11c, 11d is movable, the position of the object 8 relative to the at least first window 11a, 11b, 11c, 11d is changed dynamically when the at least first window 11a, 11b, 11c, 11d is moving, compared to the position of the object 8 relative to the at least first sensor 12a, 12b, 12c, 12d that is static.

According to an aspect the detected position and/or movement of the object 8 at the at least first active area 95a, 95b, 95c, 95d cause a certain operation of the window 11a, 11b, 11c, 11d dependent on the relative position of the window 11a, 11b, 11c, 11d in relation to the position of the door 21a, 21b, 21c, 21d.

Reference is made to FIGS. 4A and 4B. In the illustrated example in FIG. 4A the window 11a is closed. In the FIG. 4A a detected position and/or movement of the object 8, e.g. the finger, at the active area 95b causes the window 11a to half open. When the window 11a is partly open, as illustrated in the FIG. 4B, a detected position and/or movement of the object 8, e.g. the finger, at the active area 95d causes the window 11a to close. Since the window 11a is moving, the symbols 90a, 90b, 90c, 90d of the window 11a are also moving accordingly. In the example, a detected position and/or movement of the object 8, e.g. the finger, at the active areas 95e and 95f at the door 21a, as illustrated in FIGS. 4A and 4B, will however cause the same operation of the window 11a independent on the relative position of the window 11a in relation to the position of the door 21a. In the example the vehicle occupant can either operate the window by e.g. moving a finger in any of the active areas on the window, or moving a finger in any of the active areas on the door 21a.

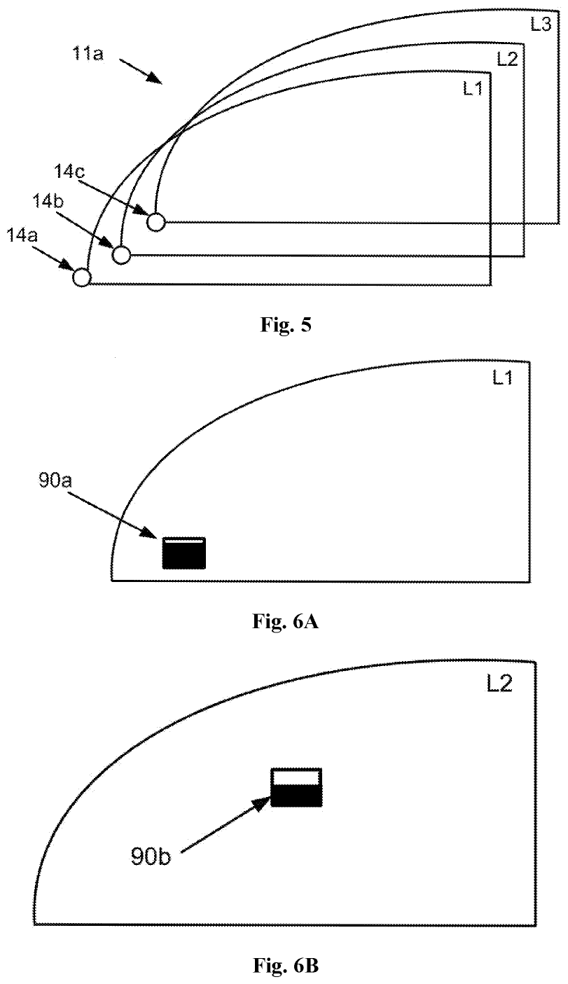

According to an aspect, as illustrated in FIG. 5, the at least first window 11a, 11b, 11c, 11d comprising at least a first layer L1, L2, L3 and the at least first symbol 90a, 90b, 90c, 90d is comprised in the at least first layer L1, L2, L3. According to an aspect the layers L1, L2, L3 are glued or pressed together to form the window 11a, 11b, 11c, 11d. According to an aspect the at least first symbol 90a, 90b, 90c, 90d is lit by light by at least a first light source 14a, 14b, 14c arranged at the at least first layer L1, L2, L3. The at least first light source 14a, 14b, 14c is illustrated in FIG. 5. According to an aspect the at least first light source 14a, 14b, 14c is configured to only emit light in one of the at least first layers L1, L2, L3. In FIG. 5 the at least first light source 14a is mounted on the edge of the at least first layer L1 configured to transport light in the first layer L1.

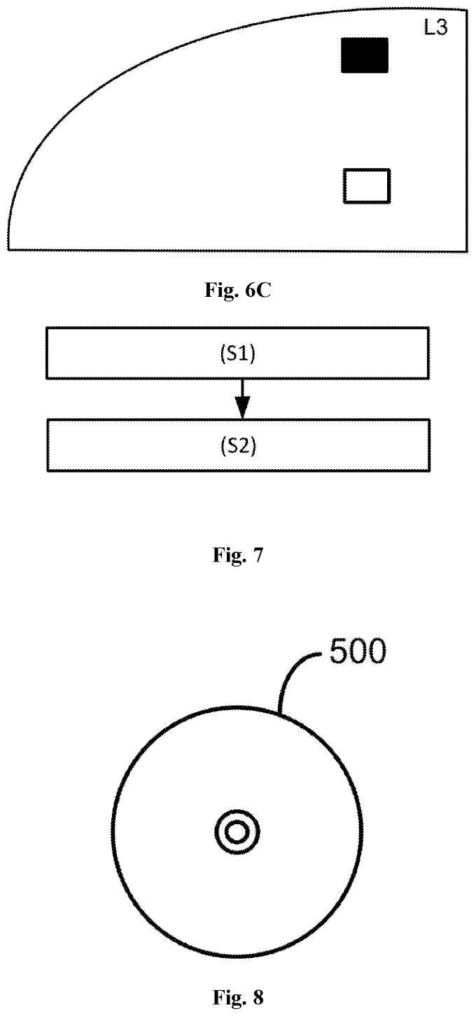

According to an aspect, the at least first window 11a comprising at least a first layer L1 and a second layer L2 and the first symbol 90a is comprised in the first layer L1 and a second symbol 90b is comprised in the second layer L2. In the FIGS. 6A and 6B example symbols 90a, 90b are illustrated in the first and second layer respectively. The FIG. 6C illustrates an example layer L3 with two symbols. This solution provides for e.g. the advantage that different symbols 90a, 90b, 90c, 90d can be comprised in different layers of the L1, L2, L3 of the at least first window 11a, 11b, 11c, 11d. In an example the different symbols 90a and 90b, as illustrated in FIGS. 6A and 6B, can be lit independently by the light source 14a and 14b respectively.

According to an aspect, the at least first window 11a comprising at least a first layer L1 and a second layer L2 and the first symbol 90a is comprised in the first layer L1 and a second symbol 90b is comprised in the second layer L2. In the FIGS. 6A and 6B the example symbols 90a, 90b illustrated in the first and second layer respectively have different appearances. According to an aspect the first symbol 90a comprised in the first layer L1 and the second symbol 90b comprised in the second layer L2 have the same appearance. In an example, using the same appearance of the symbols 90a, 90b will cause the effect of that the symbol is moving on the window 11a. For example, if the symbols 90a, 90b as illustrated in the FIGS. 6A and 6B looks the same, i.e. have the same appearance, e.g. by a same icon illustrating an “open” operation of the window 11a, the symbol 90a in FIG. 6A at the down left corner can be visible when the window 11a is closed, while if the window 11a is half open, the symbol 90b in FIG. 6B at the centre of the window 11a will instead be visible, showing the same icon illustrating an “open” operation of the window 11a.

The disclosure further proposes a method for managing movement of at least a first window 11a, 11b, 11c, 11d. The method is illustrated in FIG. 7. The method comprising the step of S1 detecting, by at least a first sensor 12a, 12b, 12c, 12d, a position and/or movement of an object 8 at or on the at least first window 11a, 11b, 11c, 11d. The method further comprising the step of S2 determining, if the position and/or movement of the object 8 detected by the at least first sensor 12a, 12b, 12c, 12d represents an intention by a vehicle occupant to move the at least first window 11a, 11b, 11c, 11d and responsive to a determination that the position and/or movement of the of the object 8 represents an intention by the vehicle occupant to move the at least first window 11a, 11b, 11c, 11d, cause the at least first window controller 10a, 10b to initiate a movement of the at least first window 11a, 11b, 11c, 11d accordingly. An advantage with the vehicle window control system 100 is that the vehicle occupant can operate the at least first window 11a, 11b, 11c, 11d intuitively by e.g. a finger at or on the window, without the need for a certain switch or button for operating the at least first window 11a, 11b, 11c, 11d.

According to an aspect the intention by the vehicle occupant to move the at least first window 11a, 11b, 11c, 11d is determined by that the position of the object 8 is at a first position P1 within at least a first active area 95a, 95b, 95c, 95d, 95e, 95f at or on the at least first window 11a, 11b, 11c, 11d and that the movement of the at least first window 11a, 11b, 11c, 11d is a first movement of the at least first window 11a, 11b, 11c, 11d. According to an aspect the at least first active area 95a, 95b, 95c, 95d, 95e, 95f is defined by an area where at least a first sensor 12a, 12b, 12c, 12d is configured to detect a position and/or movement of an object 8. This means that when the object 8 is at the first position P1 within the at least a first active area 95a, 95b, 95c, 95d, 95e, 95f, the operation of the at least first window 11a, 11b, 11c, 11d can be one of a plurality of predefined operations causing the at least first window 11a, 11b, 11c, 11d to move accordingly.

According to an aspect the method further comprising a determination of a second position P2 of the object 8 within the at least first active area 95a, 95b, 95c, 95d, 95e, 95f, and the second position P2 of the object 8 is determined within a certain time from the determination of the first position P1 of the object 8, causing the at least a first window controller 10a, 10b to initiate a movement of the at least first window 11a, 11b, 11c, 11d that is a second movement of the at least a first window 11a, 11b, 11c, 11d. This means that when the object 8 is moved from one position to another, e.g. swiped, from the first position P1 to the second position P2, the operation of the at least first window 11a, 11b, 11c, 11d can be one of a plurality of predefined operations causing the at least first window 11a, 11b, 11c, 11d to move accordingly.

The disclosure further proposes, as illustrated in FIG. 8, a computer program product 500 comprising a non-transitory computer readable medium, having thereon a computer program comprising program instructions, the computer program being loadable into a processing circuitry 102 and configured to cause execution of the method when the computer program is run by the at least one processing circuitry 102.

According to an aspect the vehicle window control system 100 is configured to carry out any or more of the aspects of the described method. According to an aspect of the disclosure, the method is carried out by instructions in a software program that is downloaded and run in the vehicle window control system 100.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

What is claimed is:

1. A vehicle window control system for managing movement of at least a first window, the vehicle window control system comprises:
at least first window comprising at least a first layer and at least first symbol comprised in the at least first layer wherein the at least first symbol is displayed only when the at least first symbol is lit by light;
at least a first light source arranged at the at least first layer of the at least first window;
at least a first window controller configured to move the at least first window;
at least a first sensor configured to detect a position and/or movement of an object; and
a processing circuitry operatively connected to the at least first sensor and the at least first window controller configured to cause the window control system to:
detect a position and/or movement of an object at or on the at least first window;
determine, if the position and/or movement of the object detected by the at least first sensor represents an intention by a vehicle occupant to move the at least first window; and
responsive to a determination that the position and/or movement of the of the object represents an intention by the vehicle occupant to move the at least first window, cause the at least first window controller to initiate a movement of the at least first window accordingly,
wherein the at least first window comprising at least a first layer and a second layer and the first symbol is comprised in the first layer and a second symbol is comprised in the second layer, and the at least first light source is configured to only emit light in one of the at least first layers.

2. The vehicle window control system according to claim 1, wherein the intention by the vehicle occupant to move the window is determined by that the position of the object is at a first position within at least a first active area at or on the at least first window and the movement of the at least first window is a first movement of the at least a first window.

3. The vehicle window control system according to claim 2, wherein the processing circuitry is configured to cause the window control system to further determine a second position of the object within the at least first active area wherein the second position of the object is determined within a certain time from the determination of the first position of the object, and cause the at least a first window controller to initiate a movement of the at least first window that is a second movement of the at least first window.

4. The vehicle window control system according to claim 1, wherein the at least first sensor is configured to emit light and detect a reflection of the emitted light caused by the object.

5. The vehicle window control system according to claim 1, wherein the at least first sensor is configured to detect light from at least a first light source.

6. The vehicle window control system according to claim 5, wherein the at least first light source is configured to emit light with a certain wavelength and/or emit a pulsing light that is pulsing at a certain frequency.

7. The vehicle window control system according to claim 1, wherein the at least first sensor is configured to determine at least one of a distance and a direction to the object relative to the position of the at least first sensor.

8. The vehicle window control system according to claim 1, wherein the at least first sensor is configured to determine a position of the object, relative to the position of the at least first window.

9. A method configured to manage movement of at least a first window of the vehicle window control system according to claim 1, the method comprising:
detecting, by at least a first sensor, a position and/or movement of an object at or on the at least first window;
determining, if the position and/or movement of the object detected by the at least first sensor represents an intention by a vehicle occupant to move the at least first window; and
responsive to a determination that the position and/or movement of the of the object represents an intention by the vehicle occupant to move the at least first window, cause the at least first window controller to initiate a movement of the at least first window accordingly.

10. The method according to claim 9, wherein the intention by the vehicle occupant to move the at least first window is determined by that the position of the object is at a first position within at least a first active area at or on the at least first window and that the movement of the at least first window is a first movement of the at least first window.

11. The method according to claim 9, wherein a second position of the object is determined within the at least first active area, and that the second position of the object is determined within a certain time from the determination of the first position of the object, causing the at least a first window controller to initiate a movement of the at least first window that is a second movement of the at least a first window.

12. A computer program product comprising a non-transitory computer readable medium, having thereon a computer program comprising program instructions, the computer program being loadable into a processing circuitry of a vehicle window control system and configured to cause execution of the method according to claim 9 when the computer program is run by the processing circuitry of the vehicle window control system.
